(19) United States
(12) Patent Application Publication
(10) Pub. No.: US 2011/0249019 A1
(43) Pub. Date: Oct. 13, 2011

(54) PROJECTION SYSTEM AND METHOD

(75) Inventor: CHIEN-LIN CHEN, Tu-Cheng (TW)

(73) Assignee: HON HAI PRECISION INDUSTRY CO., LTD., Tu-Cheng (TW)

(21) Appl. No.: 12/823,143

(22) Filed: Jun. 25, 2010

(30) Foreign Application Priority Data
Apr. 13, 2010 (TW) 99111481

(51) Int. Cl. G09G 5/36; G09G 5/02

(52) U.S. Cl. 345/593; 345/156

(57) ABSTRACT

A projection system includes first and second cameras, a projector, and a processing unit. The first camera captures an object to obtain a first image of the object. The projector projects the first image to a projection region. The second camera captures the projection region to obtain a second image of the projection region. The second image is detected to determine whether a gesture is in the projection region. If a gesture is in the projection region, a number of symbols are transmitted to the projector. The symbols are projected in the projection region to form a number of controlling symbols. The second image is further detected to determine whether one controlling symbol is selected. If one controlling symbol is selected, the processing unit controls the first camera, the second camera, or the projector.

### CROSS-REFERENCE TO RELATED APPLICATIONS

Relevant subject matter is disclosed in a co-pending U.S. patent application (Attorney Docket No. US31142) filed on the same date and having the same title, which is assigned to the same assignee as this patent application.

### BACKGROUND

1. Technical Field

The present disclosure relates to a projection system and a projection method.

2. Description of Related Art

Projectors are often used by teachers or presenters to project teaching material onto a screen. When the teacher wants to process the teaching materials, such as changing pages of the teaching materials, the teacher needs to return to the computer system to do so, or remain at the computer, unable to move around in the classroom, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a projection system used in a classroom, the projection system including a storage unit.

FIG. 2 is a block diagram of the storage unit of FIG. 1.

FIGS. 3-5 are schematic diagrams of operating the projection system of FIG. 1.

FIGS. 6A and 6B are a flowchart of an exemplary embodiment of a projection method.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

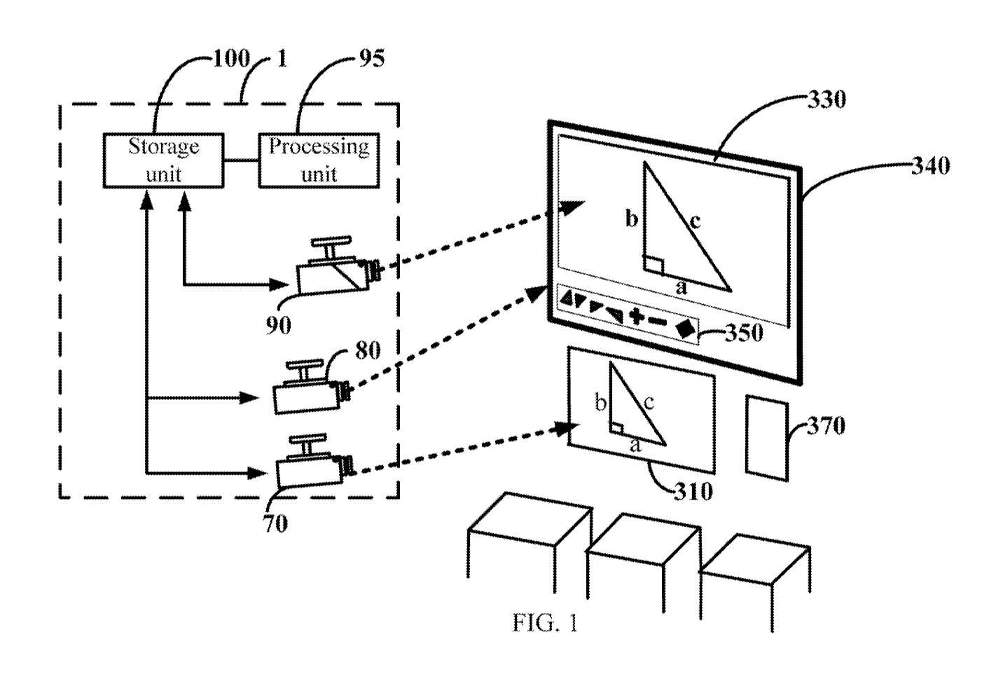

Referring to FIG. 1, an exemplary embodiment of a projection system 1 includes a first camera 70, a second camera 80, a projector 90, a storage unit 100, and a processing unit 95. The projection system 1 may be used in a group setting such as in a classroom.

The first camera 70 can be used to capture images of an object, which are then received by the projector 90 and projected on a projection region 330. The second camera 80 captures an image of the projection region 330 and transmits the image to the storage unit 100. The processing unit 95 accesses the images stored in the storage unit 100 and analyzes the images of the projection region 330 from the second camera 80 to determine whether there is a match to a predetermined gesture, such as the pointing of a finger or a hand formed in the shape of a gun or the okay sign, in the projection region 330. Upon the condition that the gesture is in the projection region 330, the processing unit 95 transmits a plurality of symbols to the projector 90. The projector 90 projects the symbols in the projection region 330 to form a controlling region. The second camera 80 also captures images of the controlling region. The processing unit 95 further analyzes the images of the controlling region from the second camera 80 to determine whether the controlling region is selected. Upon the condition that the controlling region is selected, the processing unit 95 controls the first camera 70, the second camera 80, or the projector 90 correspondingly. In the embodiment, the first camera 70 and the second camera 80 are Pan/Tilt/Zoom (PTZ) cameras.

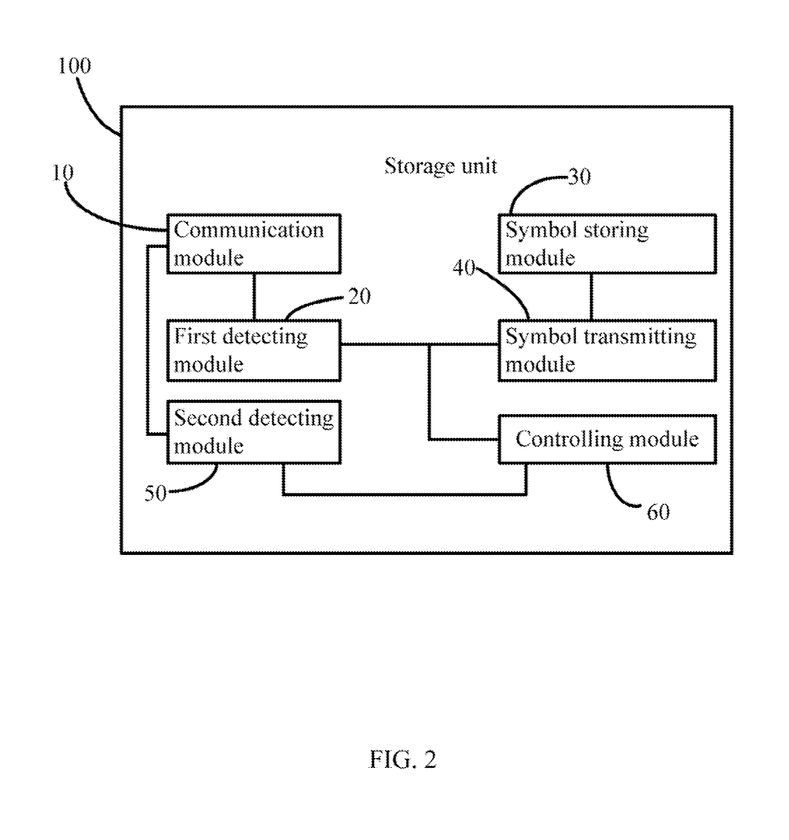

Referring to FIG. 2, the storage system 100 includes a communication module 10, a first detecting module 20, a symbol transmitting module 40, a second detecting module 50, and a controlling module 60 which may include one or more computerized instructions and are executed by the processing unit 95, and a symbol storing module 30.

The communication module 10 transmits the images of the object captured by the first camera 70 to the projector 90. The projector 90 projects the images to the projection region. In addition, the communication module 10 further transmits the images of the projection region and the controlling region from the second camera 80 to the first detecting module 20 and the second detecting module 50 respectively.

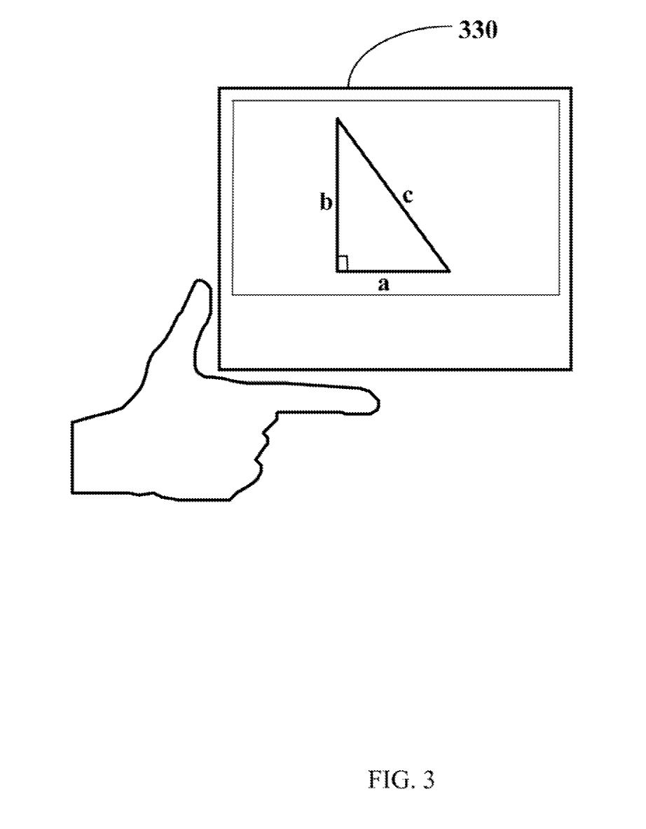

The first detecting module 20 detects the images captured by the first camera 70 to determine whether there is a predetermined gesture in a predetermined position of the images of the projection region. Referring to FIG. 3, in the embodiment, the predetermined positions of the image of the projection region may refer to four corners of the image of the projection region 330. When the gesture is at one of the four corners, the first detecting module 20 outputs a first detection signal to the symbol transmitting module 40.

The symbol storing module 30 stores four symbol groups corresponding to the four corners of the image of the projection region 330. Each symbol group includes a plurality of symbols, such as “+” and “−”.

The symbol transmitting module 40 transmits a corresponding symbol group to the projector 90 when the gesture is at one of the four corners of the images of the projection region 330. The projector 90 further projects the symbol group to the projection region 330 to form the controlling region 350. The controlling region 350 includes a plurality of controlling symbols. For example, when the gesture is at the lower left corner of the image of the projection region 330, the symbol transmitting module 40 transmits the symbol group corresponding to the lower left corner to the projector 90 and the projector 90 projects the symbol group including the plurality of symbols in the projection region 330. As a result, the controlling region 350 is displayed at the lower left corner of the projection region 330. Similar to the lower left corner, when the gesture is at the lower right corner of the images of the projection region 330, the symbol transmitting module 40 transmits the symbol group corresponding to the lower right corner to the projector 90 and the projector 90 projects the symbol group including the plurality of symbols in the projection region 330. As a result, the controlling region 350 is displayed on the lower right corner of the projection region 330.

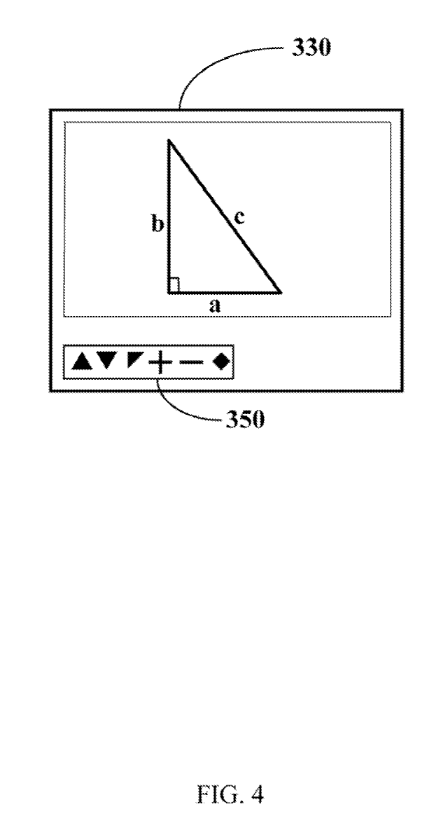

Referring to FIG. 4, the controlling region 350 which may be at the lower left corner of the projection region 330 includes the controlling symbols “▴”, “▾”, “ [symbol] ”, “ [symbol] ”, “+”, “−”, and “♦”. Each controlling symbol represents a controlling action. For example, “+” represents to zoom in the projection of the object in the projection region 330. In another embodiment, the symbol storing module 30 stores only one symbol group. When the gesture is at the lower right corner of the image of the projection region 330, the controlling symbols corresponding to the symbol group would appear on the lower right corner to the projector 90. When the gesture is at the lower left corner of the images of the projection region 330, the controlling symbols corresponding to the symbol group would appear on the lower left corner to the projector 90 and the projector 90 projects the symbol group including the plurality of symbols in the projection region 330.

In the embodiment, the first detection signal is further transmitted to the controlling module 60. The controlling module 60 controls the projector 90 to change the color of an edge of the projection region 330, to tell users that the controlling region 350 is activated.

The second detecting module 50 detects the image of the controlling region 350 captured by the second camera 80, to determine whether one of the plurality of controlling symbols are selected. In the embodiment, the second detecting module 50 determines whether one of the controlling symbols is hidden in the image from the second camera 80 to know whether the controlling symbol is selected. When one of the controlling symbols is not in the image, the controlling symbol is regarded as being hidden. When one of the controlling symbols is selected, the second detecting module 50 transmits a second detection signal corresponding to the selected controlling symbol to the controlling module 60.

The controlling module 60 controls the first camera 70, the second camera 80, or the projector 90 according to the second detection signal from the second detecting module 50. For example, when a second detection signal corresponding to “+” is selected, the controlling module 60 controls a lens of the first camera 70 to withdraw. As a result, an image of the object with a larger size is projected on the projection region 330.

Referring to FIG. 1 again, the projection system 1 is used in a classroom. A chalkboard 310 is in the classroom, and the chalkboard 300 is regarded as the object. The first camera 70 captures images of the chalkboard 310. The communication module 10 transmits the images of the chalkboard 310 to the projector 90. The projector 90 projects the images of the chalkboard 310 to the projection region 330. The projection region 330 is on a screen in the classroom. The projection region 330 includes an edge 340.

In the embodiment, a first symbol group corresponding to the lower left corner of the projection region 330 includes the plurality of symbols. The first symbols include “▴”, “▾”, “ [symbol] ”, “ [symbol] ”, “+”, “−”, and “♦”. “▴” represents: move the first camera 70 up. “▾” represents: move the first camera 70 down. “ [symbol] ”represents: move the first camera 70 right. “ [symbol] ”represents: move the first camera 70 left. “+” represents: zoom in the images of the chalkboard 310. “−” represents: zoom out the images of the chalkboard 310. “♦” represents: connect the projector 90 to other devices, such as a computer system.

Referring to FIG. 3, the gesture is at the lower left corner of the projection region 330. The symbol transmitting module 40 then transmits the symbols “▴”, “▾”, “ [symbol] ”, “ [symbol] ”, “+”, “−”, and “♦” to the projector 90. The projector 90 projects the symbols in the projection region 330. The image of the symbols forms the controlling symbols. The controlling symbols are arranged in a row and on the lower left corner of the projection region 330 as shown in FIG. 4. The controlling symbols form the controlling region 350. In other embodiments, the controlling region 350 may be arranged in other modes, such as in two rows.

The second camera 80 further captures an image of the controlling region 350. The communication module 10 further transmits the image of the controlling region 350 captured by the second camera 80 to the second detecting module 50.

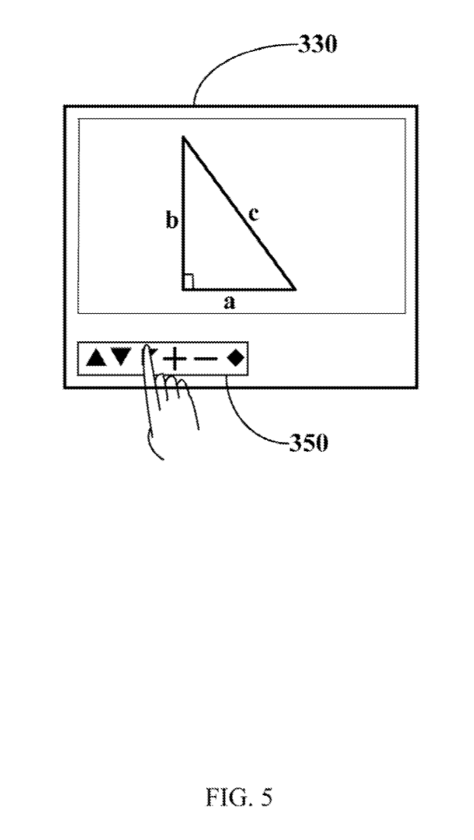

Referring to FIG. 5, when a user uses a finger to cover the controlling symbol “ [symbol] ” in the controlling region 350, pixel values at pixels corresponding to a position of the controlling symbol “ [symbol] ” in the image change. As a result, the second detecting module 50 outputs a corresponding second detection signal to the controlling module 60. In the embodiment, the second detecting module 50 stores an image of the controlling region 350 when the controlling region 350 is not selected. When the second detecting module 50 receives the image captured by the second camera 80, the second detecting module 50 compares the two images to determine which controlling symbol is selected.

The controlling module 60 controls the first camera 70 to move right. At this condition, the first camera 70 captures an image of an object on the right of the chalkboard 310, such as a duty list 370 (shown in FIG. 1). The image of the duty list 370 is transmitted to the projector 90 and the projector 90 projects the image of the duty list 370 in the projection region 330.

When the gesture is at the lower left corner of the projection region 330 again, the symbol transmitting module 40 then stops transmitting the symbols “▴”, “▾”, “ [symbol] ”, “ [symbol] ”, “+”, “−”, and “♦” to the projector 90. As a result, the controlling region 350 disappears from the projection region 330.

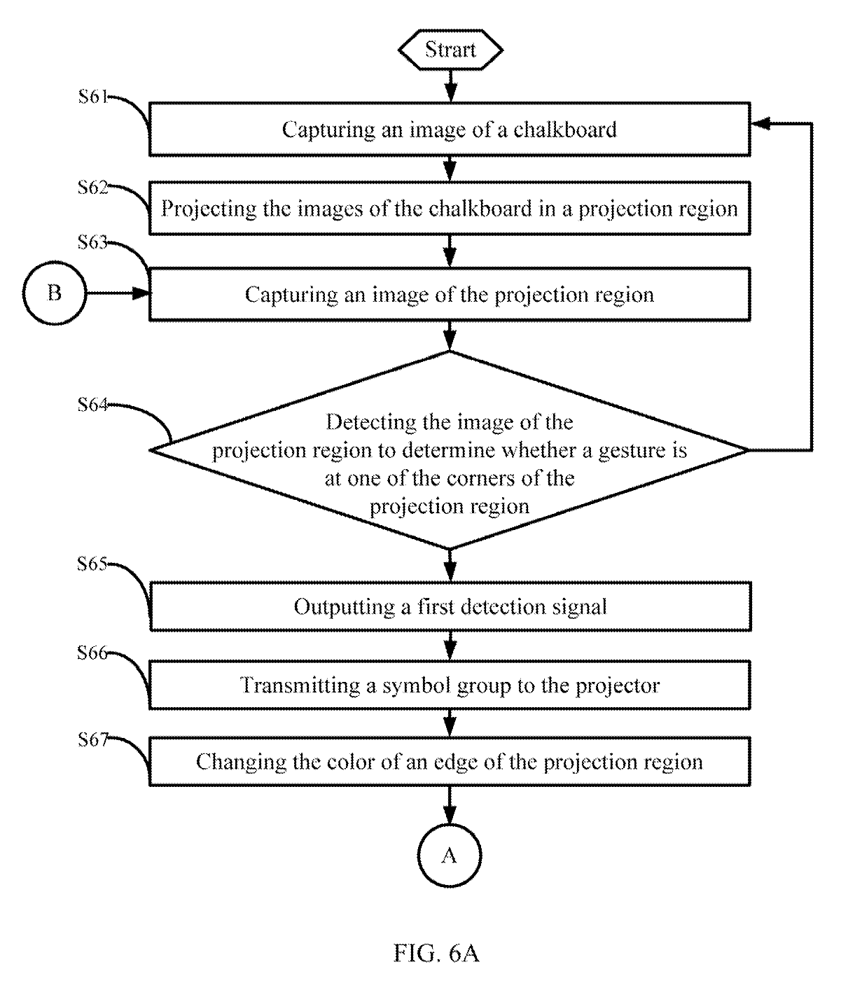

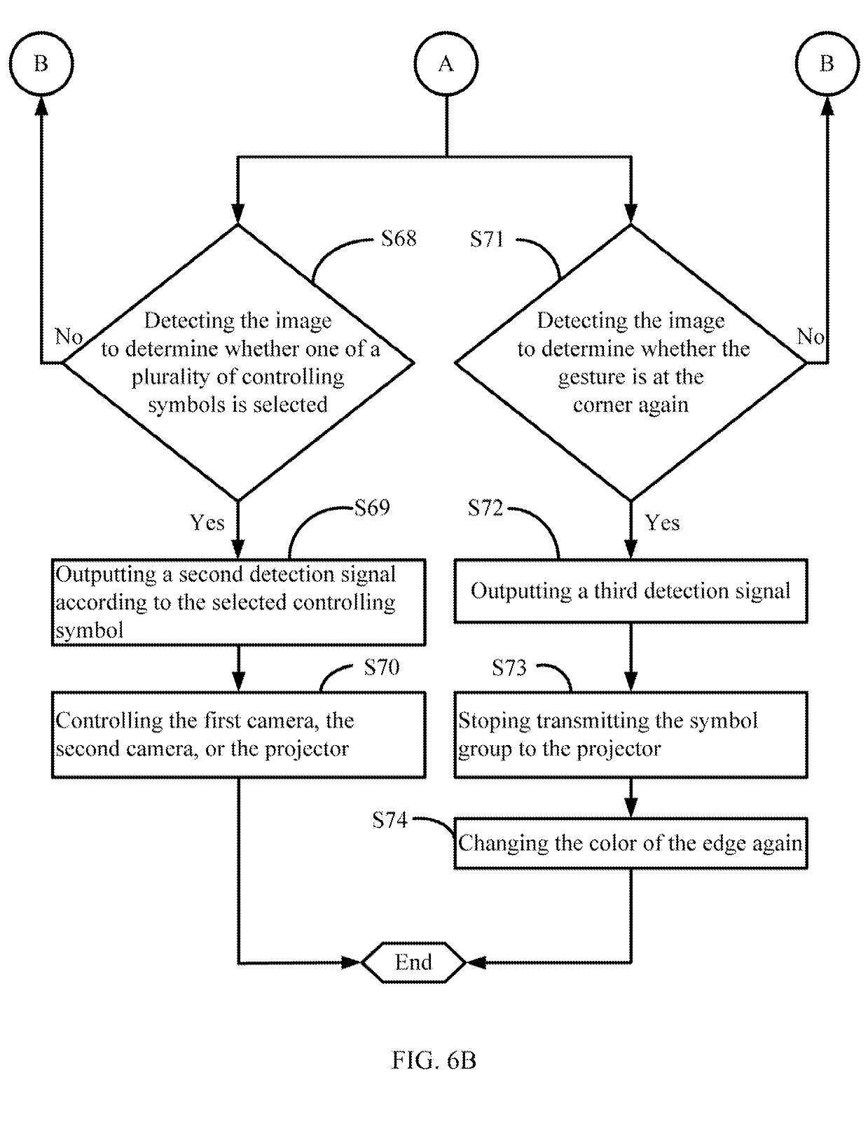

Referring to FIG. 6, an exemplary embodiment of a projection method includes the following steps.

In step S61, the first camera 70 captures images of the chalkboard 310.

In step S62, the projector 90 projects the images of the chalkboard 310 in the projection region 330.

In step S63, the second camera 80 captures images of the projection region 330.

In step S64, the first detecting module 20 detects the images of the projection region 330 to determine whether a predetermined gesture is at one of the corners of the projection region 330. Upon the condition that there is no predetermined gesture in the projection region 330, the process returns to S61. Upon the condition that the predetermined gesture is at one of the corners of the projection region 330, the process flows to step S65.

In step S65, the first detecting module 20 outputs a first detection signal.

In step S66, the symbol transmitting module 30 transmits a symbol group corresponding to the first detection signal to the projector 90 and the projector 90 projects the symbol group including the plurality of symbols in the projection region 330. The plurality of symbols forms a plurality of controlling symbols in the projection region 330. The controlling symbols in the projection region 330 forms a controlling region 350.

In step S67, the controlling module 60 controls the projector 90 to change the color of the edge 340 of the projection region 330 to indicate that the controlling region 350 is activated. The process then flows to step S68 and S71.

In step S68, the second detecting module 50 detects another image of the projection region 330 to determine whether one of the controlling symbols is selected. Upon the condition that there is a controlling symbol selected, the process flows to step S69. Upon the condition that there is no controlling symbol selected, the process returns to S63.

In step S69, the second detecting module 50 outputs a second detection signal according to the selected controlling symbol. The second detection signal is transmitted to the controlling module 50.

In step S70, the controlling module 50 controls the first camera 70, the second camera 80, or the projector 90 according to the second detection signal.

In step S71, the first detecting module 20 detects the image of the projection region 330 to determine whether the gesture is at the corner of the projection region 330 again. Upon the condition that the appointed gesture is not at the corner of the projection region 330, the process flows to step 61. Upon the condition that the gesture is at the corner of the projection region 330 again, the process flows to step S72.

In step S72, the first detecting module 20 outputs a third detection signal.

In step S73, the symbol transmitting module 30 stops transmitting the symbol group to the projector 90. As a result, the controlling region 350 disappears from the projection region 330.

In step S74, the controlling module 60 controls the projector 90 to change the color of the edge 340 of the projection region 330 again to indicate that the controlling region 350 is inactivated.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A projection system comprising:
a first camera to capture an object to obtain a first image of the object;
a projector to project the first image of the object to a projection region;
a second camera to capture the projection region to obtain a second image of the projection region;
a processing unit connected between each of the first camera and the second camera, and the projector; and
a storage unit connected to the processing unit and storing a plurality of programs to be executed by the processing unit, wherein the storage unit comprises:
a first detecting module to detect the second image of the projection region to determine whether there is a gesture in the projection region, and output a first detection signal upon the condition that there is a gesture in the projection region;
a symbol transmitting module to transmit a plurality of symbols to the projector according to the first detection signal, wherein the projector projects the plurality of symbols in the projection region to form a plurality of controlling symbols;
a second detecting module to detect the second image of the projection region to determine whether one of the plurality of controlling symbols is selected, and to output a second detection signal according to a selected controlling symbol upon the condition that one of the plurality of controlling symbols is selected; and
a controlling module to control the first camera, the second camera, or the projector according to the second detection signal.

2. The projection system of claim 1, wherein the second detecting module further stores a third image of the projection region upon the condition that the plurality of controlling symbols are not selected, and after the second detecting module receives the second image of the projection region, the second detecting module compares the second image with the third image to determine whether one of the plurality of controlling symbols is selected.

3. The projection system of claim 1, wherein the first camera and the second camera are Pan/Tilt/Zoom cameras.

4. The projection system of claim 1, wherein the controlling module further controls the projector to change a color of an edge of the projection region according to the first detection signal.

5. The projection system of claim 4, wherein the first detecting module further detects the second image of the projection region to determine whether the gesture is in the projection region again, and output a third detection signal upon the condition that the gesture is in the projection region again.

6. The projection system of claim 5, wherein the controlling module further controls the projector to change a color of the edge of the projection region again according to the third detection signal.

7. A projection method comprising:
capturing an object to obtain a first image of the object by a first camera;
projecting the first image of the object to a projection region by a projector;
capturing a second image of the projection region by a second camera;
detecting the second image of the projection region to determine whether there is a gesture in the projection region;
outputting a first detection signal upon the condition that there is a gesture in the projection region;
transmitting a plurality of symbols to the projector according to the first detection signal;
projecting the plurality of symbols to the projection region by the projector, wherein the plurality of symbols forms a plurality of controlling symbols;
detecting the second image of the projection region to determine whether one of the plurality of controlling symbols is selected;
outputting a second detection signal according to a selected controlling symbol upon the condition that one of the plurality of controlling symbols is selected; and
controlling the first camera, the second camera, or the projector according to the second detection signal.

8. The projection method of claim 7, wherein the step of “detecting the second image of the projection region to determine whether one of the plurality of controlling symbols is selected” comprises:
comparing the second image of the projection region with a third image of the projection region upon the condition that the plurality of controlling symbols are not selected, to determine whether one of the plurality of controlling symbols is selected.

9. The projection method of claim 7, wherein the step of “detecting the second image of the projection region to determine whether one of the plurality of controlling symbols is selected” comprises:
determining whether one of the plurality of controlling symbols is covered to determine whether one of the plurality of controlling symbols is selected.

10. The projection method of claim 7, after the step of “outputting a first detection signal upon the condition that there is a gesture in the projection region” further comprising:
changing a color of an edge of the projection according to the first detection signal.

11. The projection method of claim 10, after the step of “projecting the plurality of symbols to the projection region, wherein the plurality of symbols forms a plurality of controlling symbols” further comprising:
detecting a third image of the projection region to determine whether the gesture is in the projection region again;
outputting a third detection signal upon the condition that the gesture is in the projection region again; and
stopping transmitting the plurality of symbols to the projector according to the third detection signal.

12. The projection method of claim 11, after the step of “stopping transmitting the plurality of symbols to the projector according to the third detection signal” further comprising:
changing a color of the edge of the projection region again according to the third detection signal.
